(19) United States
(12) Patent Application Publication
(10) Pub. No.: US 2023/0276999 A1
(43) Pub. Date: Sep. 7, 2023

(54) KITCHEN APPLIANCE WITH SCALE FOR A USER INTERFACE

(71) Applicant: Vorwerk & Co. Interholding GmbH, Wuppertal (DE)

(72) Inventor: Kevin Schmitz, Haan (DE)

(21) Appl. No.: 18/142,369

(22) Filed: May 2, 2023

(30) Foreign Application Priority Data
Mar. 5, 2022 (EP) 227171229.2

(51) Int. Cl. A47J 43/07; A47J 43/046

(52) U.S. Cl. CPC A47J 43/0761; A47J 43/046; A47J 2043/0733

(57) ABSTRACT

The present disclosure relates to a kitchen appliance having a control device for controlling the operation of the kitchen appliance and a scale for measuring a weight of foodstuffs, characterized in that the control device of the kitchen appliance is able to control the operation of the kitchen appliance in dependence on a pressing on the upper side of the kitchen appliance detected by the scale in dependence on the position of the pressing.

### PRIORITY CLAIM

This application claims priority to European Patent Application Serial No. 22168936.7, filed 20 Apr. 2022, which is expressly incorporated by reference herein.

### FIELD OF THE DISCLOSURE

The present disclosure relates to a kitchen appliance having a scale for measuring a weight of foodstuffs.

### BACKGROUND

A kitchen appliance is an appliance used in a kitchen for preparing a food and in connection with preparing a food. A kitchen appliance may comprise a preparation space in which a food can be prepared. The preparation space may be an inseparable component of the kitchen appliance. However, the preparation space may also be provided by a preparation vessel that is a detachable component of the kitchen appliance. If the preparation vessel is a detachable component, the preparation vessel can be used separately from a base appliance of the kitchen appliance.

Foodstuffs can be brought into the preparation vessel and/or preparation space. Foodstuffs located in the preparation space and/or preparation vessel can be processed by the food preparation vessel and thus be prepared. For example, the kitchen appliance can weigh, mix, chop and/or temper, for example heat, one or more foodstuffs located in the preparation vessel and/or preparation space.

Examples of kitchen appliances are cooking appliance, food processor, stove, oven, microwave, refrigerator, freezer, kitchen scale, waffle iron, deep fryer and steam cooker.

The scale can be used to determine the weight of foodstuffs. For example, the kitchen appliance may comprise a vessel into which foodstuffs may be brought so as to be able to determine the weight of foodstuffs brought therein by means of the scale. A scale may comprise one or more force sensors to determine a weight.

A food processor with a base appliance, a preparation vessel and a weighing device, i.e. a scale, is known from the publication EP 3 398 495 A1. Weight changes can be determined using the weighing device. By means of determined weight changes, states of the food processor can be determined, for example a lifting of the food processor or a weight of foodstuffs that have been brought into the preparation vessel.

A device for processing foodstuffs with a weight sensor is known from publication EP 3 781 002 B1. The weight sensor can determine the weight of foodstuffs. Furthermore, a control unit can receive measurement signals from the weight sensor and in dependence thereon control the operation of the apparatus.

It is the task of the present disclosure to further develop a kitchen appliance.

### SUMMARY

A kitchen appliance with a control device for controlling the operation of the kitchen appliance is disclosed. The kitchen appliance comprises a scale for measuring a weight of foodstuffs. The kitchen appliance is configured such that the scale is able to detect a pressing (pushing) on the upper side of the kitchen appliance. If the scale detects a pressing, the position of the pressing can be determined by means of the control device. The control device is able to control the operation of the kitchen appliance in dependence on the position.

The kitchen appliance may be configured such that a distinction can be made between a tilting movement caused by lateral pressing and pressing on the upper side, lateral pressing can be an additional way of controlling the kitchen appliance in dependence on whether it is pressed on the upper side or laterally.

The kitchen appliance is configured such that the scale can detect not only the pressing on the upper side, but moreover the position of the pressing, that is, the position on the upper side on which pressing was performed. For example, if pressing is performed on a central position on the upper side with a first force, the scale measures at least a first measured value. If pressing is performed on a position adjacent to the central position on the upper side with the first force, the scale measures at least a second measured value. The two measured values then differ because different positions were pressed. The scale can therefore detect that different positions were pressed. The measured value(s) of the scale are then a measure of the position on which pressing was performed.

The control device is configured such that it can determine a position of pressing based on one or more measurement results of the scale. For example, the control device may be configured such that it can detect whether pressing has been performed on a central position or on a position adjacent to the central position.

present disclosureThe present disclosure allows the upper side of the kitchen appliance to be used for a pressing for the purpose of controlling the operation. Thus, a user interface is available that can be implemented with components of a kitchen appliance that already exist for other reasons. The user interface can therefore be provided with little technical effort. This user interface is very insensitive to external influences. By means of the user interface many operating states of the kitchen appliance can be changed.

Providing multiple force sensors so that a surface of an appliance can be used two-dimensionally as a user interface for control or operation of the appliance can also be applied to other appliances. For example, the appliance may be another household appliance such as a vacuum cleaner. The vacuum cleaner may thus be configured such that the position of a pressing on its upper side can be detected and a control device of the vacuum cleaner is able to control the operation of the vacuum cleaner in dependence on the position of the pressing. The advantage of such an interface consists in the fact that the vacuum cleaner can be operated via a closed and robust surface and the technical manufacturing effort is low. In the case of the vacuum cleaner, the function of being able to weigh something is omitted. This applies in the same way to many other devices. Otherwise, the previously said also applies to other devices that are not a kitchen appliance and/or that are not intended and suitable for weighing, for example, foodstuffs.

The surface of each appliance may have symbols, signs, words, letters, elevations and/or indentations by which can be indicated which pressure on which position can do what in dependence on appliance states, if necessary. Alternatively or additionally, symbols, signs, words, letters, elevations and/or indentations may indicate device states, for example to indicate which inputs are possible for which device state. For example, the upper side of a device may have a switch icon. If the switch icon is pressed, for example, this can switch the device on or off. A loudspeaker symbol can be shown on the upper side. Pressing the loudspeaker symbol can then, for example, switch the loudspeaker of the device on or switch it off. A symbol for a slider or rotary control may be shown on the upper side. Sliding along the symbol for the slider or along the outer edge of the knob symbol can then, for example, change a power of the device, such as the suction power of a vacuum cleaner device.

For example, a circular curvature to the inside or outside can indicate the position for a pressing. A groove can indicate the position for a wiping or sliding movement.

In addition to the possibility of controlling and thus also operating an appliance by means of a scale or by means of force sensors, an appliance or kitchen appliance can also comprise classic user interfaces such as a touch screen, rotary knob or switch.

The present disclosure also includes that a portion of a kitchen appliance can be lifted by pulling it upward, thereby controlling the operation of the kitchen appliance. For example, the kitchen appliance may comprise a preparation vessel that is loosely placed on a base appliance of the kitchen appliance during operation. When the preparation vessel is lifted, operation of the kitchen appliance may be controlled thereby by means of the control device. For example, a power supply to a heating device of the kitchen appliance can be interrupted as soon as the scale detects a lifting of the preparation vessel. This embodiment of the present disclosure also provides an independent solution to the problem of providing a technically simple and robust user interface.

The present disclosure is explained in more detail below.

### BRIEF DESCRIPTIONS OF THE DRAWINGS

The figures show:

FIG. 1 shows a first kitchen appliance, namely a food processor.

FIG. 2 shows a top view of a second kitchen appliance.

FIG. 3 shows a top view of a third kitchen appliance.

FIG. 4 shows measurement results.

FIGS. 5 and 6 show a top view of a kitchen appliance with predetermined input positions.

FIG. 7 shows an analysis of the measurement results from FIG. 4.

FIG. 8 shows a flow chart.

### DETAILED DESCRIPTION

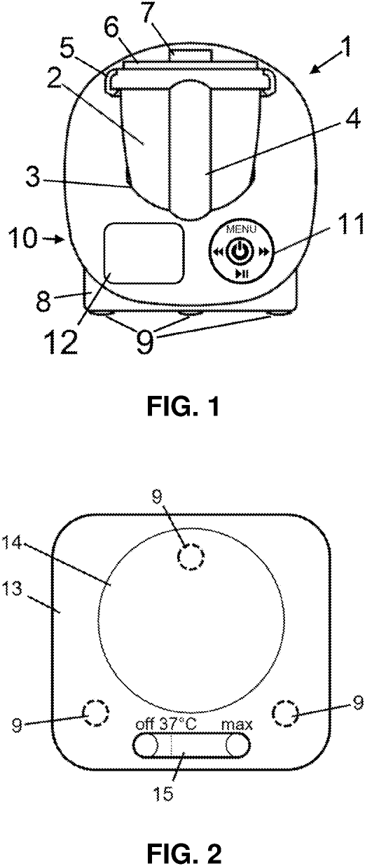

FIG. 1 shows a food processor 1. The food processor 1 comprises a vessel 2 as preparation space for a food, which is inserted into a holder 3 of the food processor 1. The vessel 2 comprises a handle 4 for easily removing the vessel 2 from the holder 3 of the food processor 1. The food processor comprises a closing mechanism with rotatably mounted arms 5. In the closed position shown in FIG. 1, the arms 5 enclose a lid 6. As a result, the lid 6 is then firmly connected to the vessel 2. If the closing mechanism is opened by rotating the arms 5, then the lid 6 can be removed from the vessel 2.

The lid 6 comprises an opening into which a vessel 7 is inserted. The vessel 7 closes the opening in the lid 6. The vessel 7 can be lifted off the opening at any time, so that an opening is then provided through which an ingredient can be filled into the vessel 2. The vessel 7 may serve as a dosing aid. The vessel 7 can be transparent and thus allow a view into the preparation vessel.

For setting up, the food processor 1 comprises a foot part 8 with three feet 9. The three feet 9 are three force sensors 9 that can measure a force independently of each other. If pressing is performed on the upper side of the food processor 1, all three force sensors 9 each measure a force that depends not only on the strength of the pressing but also on the position of the pressing.

A force sensor 9 may comprise a spring body. Each spring body may be compressed or stretched by pressing on the upper side of the food processor 1. A strain gauge may be disposed on the upper side of the spring body such that the strain gauge is compressed when the spring body is compressed. Thus, the length of the strain gauge can be shortened by compressing the spring body. The length of the strain gauge can be increased by stretching the spring body. Changing the length of the strain gauge changes its electrical resistance. The electrical resistance is thus, for example, a measure of the force with which the spring body has been compressed. The electrical resistance of each strain gauge can be determined by means of the control device of the food processor 1. The control device thus receives information about the forces that have been applied to the feet 9.

The three feet 9 may be arranged such that they span a triangle with three sides of equal length. In other words, the three feet are arranged along a circle and immediately adjacent feet are equally spaced from each other. For example, the length of each side of the triangle may be at least 5 cm, at least 6 cm, at least 8 cm, or at least 10 cm. Such an arrangement enables particularly accurate positioning with a low manufacturing cost.

The base part 8 and the holder 3 are part of the base appliance 10 of the food processor 1. In the base appliance 10, for example, one or more motors, a control unit, a radio unit for wireless receiving and/or sending of data and/or a power supply to the heating element of the preparation vessel 2 are arranged. A motor in the base appliance may be a drive for a mixing and/or cutting tool in the preparation vessel 2. A motor in the base appliance may be a drive for the arms 5 and thus for a locking of the lid 6.

The base appliance 10 comprises an upper side. A visual representation of a circle 11 may be located on the upper side. Within the circle, a forward symbol may be shown at the right edge. A backward symbol may be shown at the left edge. A start-pause symbol may be shown at the lower edge. At the upper edge, a “MENU” label may be located within the circle 11. There may be an on-off switch symbol in the center of the circle 11.

Pressing the on/off switch symbol can switch the food processor on or off, for example. Switching on means here that an operating system of the food processor 1 starts, i.e. is booted up, and a display 12 of the food processor 1 is switched on. Switching off means that the operating system of the food processor 1 is shut down and the display 12 of the food processor 1 is switched off.

If the food processor 1 is switched on, the other symbols within the circle 11 can be used to control and operate the food processor 1. By pressing on the label “MENU”, for example, a representation on the display 12 can be changed. On the display 12, for example, an indication may appear that a desired temperature can be adjusted to which the interior of the preparation vessel 2 can and should be heated. By subsequently pressing the forward symbol once, the desired temperature can be increased by a step of 5° C., for example. By pressing the forward symbol for a long time, the desired temperature is increased continuously in steps, for example, until it is no longer pressed or the maximum possible desired temperature is adjusted. Each step may be an increase of the desired temperature by 5° C. or 10° C. for example. However, there may also be steps of different lengths, e.g. initially an increase of 5° C. per step or stage and later by a different value of, for example, only 3° C. or 4° C., in order, for example, to be able to adjust a temperature of 98° C. or 99° C. as the desired temperature. By pressing the backward symbol once, the desired temperature can be reduced by one step of 5° C., for example. By pressing the backward symbol for a long time, the desired temperature is reduced continuously in steps, for example, until it is no longer pressed or the minimum possible desired temperature is adjusted. By subsequently pressing the start-pause symbol, the heating of the interior can be started, for example. By pressing the start-pause symbol again, the heating can then be interrupted, for example.

By pressing the “MENU” label again, the display 12 can be changed so that, for example, a rotation speed for a mixing and/or cutting tool located in the preparation vessel can now be adjusted. By subsequently pressing the forward symbol once, for example, the rotational speed of the mixing and/or cutting tool can be increased by one step, for example from step 1 to step 2. By pressing the forward symbol for a long time, the rotation speed is increased continuously in steps, for example, until it is no longer pressed or the maximum possible step is adjusted. By pressing the backward symbol once, the rotation speed can be reduced by one step, for example. By pressing the backward symbol for a long time, the rotation speed is reduced continuously in steps, for example, until it is no longer pressed or the minimum possible rotation speed is adjusted. By subsequently pressing the start-pause symbol, it is possible, for example, to start rotating the mixing and/or cutting tool at the adjusted rotational speed. Pressing the start-pause symbol again can then interrupt the rotation, for example.

By pressing the “MENU” label again, the display 12 can be changed so that, for example, a timer can now be adjusted. By subsequently pressing the forward symbol once, a time period for the timer can be increased by one second, for example. By pressing the forward symbol for a long time, the time period is increased continuously until it is no longer pressed or the maximum possible time period is adjusted. By pressing the backward symbol once, the time period can be decreased by one second, for example. By pressing the backward symbol for a long time, the time period is continuously reduced until it is no longer pressed or the minimum possible time period is adjusted. By adjusting the timer, it is possible, for example, to adjust how long heating is performed and/or how long the mixing and/or cutting tool is rotated. Once the timer has expired, heating and/or rotating of the mixing and/or cutting tool, for example, is stopped in an automated manner.

If the food processor 1 is switched on and pressing is performed on the lid 6, for example, a weight display appears on the display 12 of the food processor 1. If a foodstuff is then filled into the preparation vessel, the weight of the foodstuff filled in is shown on the display 12. If, for example, the “MENU” label is subsequently pressed, the indication of a weight on the display 12 disappears, for example, and another indication may appear instead.

It may also be that a circular movement along the circle 11 can be used for controlling the operation of the food processor 1.

FIG. 2 shows a top view of a kitchen appliance having an upper side 13. There is a heating surface 14 on the upper side 13. The heating surface 14 can be heated. The heating surface 14 may be a placement surface for a preparation vessel 2. At the lower edge of the image below the heating surface 14, a slider symbol 15 is visually represented. Between the slider symbol 15 and heating surface 14 there is a label. The word “off” can be seen on the left side of the label. In the central area there is the label “37° C.”. On the far right there is the label “max”. Through the slider symbol 15, a desired temperature for the heating surface 14 can be adjusted by performing a sliding movement or wiping movement along the slider symbol 15. If the circle symbol below “off” is pressed, the heating is switched off. The label “37° C.” shows the position on the slider symbol 15 that can be reached by a sliding or wiping movement to adjust the desired temperature to 37° C. The label “max” shows the position on the slider symbol 15 that can be reached by a sliding or wiping movement to adjust the desired temperature to 37° C. The label “max” indicates the position on the slider symbol 15 that can be reached by a sliding or wiping movement to adjust the maximum possible desired temperature. For adjusting a desired temperature, it may be necessary to always perform a wiping movement starting from the “off” position along the slider symbol 15 shown on the upper side 13 in order to be able to adjust a desired temperature. This avoids that accidental force effects can result in an unscheduled adjustment of a desired temperature.

Alternatively, a specific temperature value can also be adjusted in the case of a symbol 15 by simply pressing it. This means that wiping movements can also be dispensed with. The symbol 15 may also comprise further information on temperature values, such as 100° C., for example, in order to be able to easily select a desired temperature value of 100° C.

For reliability reasons, it may be necessary to first press the area of the visually displayed slider symbol 15 once or several times for adjusting a desired temperature, for example, in order to then be able to adjust a desired temperature in a time-limited manner by a wiping movement.

On the basis of the force increase and/or the type and strength of the force action, a distinction can be made between an unscheduled force action and a scheduled force action. Only those forces which are recognized as scheduled (planned) can adjust a desired temperature. Also in this way it can be avoided alternatively or in addition that desired temperatures can be adjusted unscheduledly.

Dashed circles show the position of the force sensors 9, which are located below the upper side 13, i.e. below the plane of FIG. 2. The force sensors can be located on the underside of the kitchen appliance and serve as feet. However, the upper side may also be formed by a movably arranged plate and the force sensors 9 may, for example, be arranged directly below the plate. The force sensors 9 may span a triangle with three equal sides as shown.

The kitchen appliance may have a display that is located on a side wall, for example. The kitchen appliance can, for example, be connected wirelessly to another appliance in order to be able to use a display of the other appliance. The display may show, for example, an adjusted desired temperature. The display may show, for example, a measured weight.

If a preparation vessel has been placed on the heating surface, the control device of the kitchen appliance may, for example, detect in an automated manner when a foodstuff is placed in the preparation vessel. An automated detection is possible due to the position detection, an analysis of the increase in force and/or the force, and specifically in terms of the magnitude and/or length of the force applied by the foodstuff to the heating surface 14. Such automated detection can be performed by comparison with stored reference values. If it is detected in an automated manner that a foodstuff is placed in the vessel, for example, a weight measurement and display of the measured weight can be performed in an automated manner. However, such automated detection can also be used in other ways, for example as a prerequisite for heating the heating surface 14.

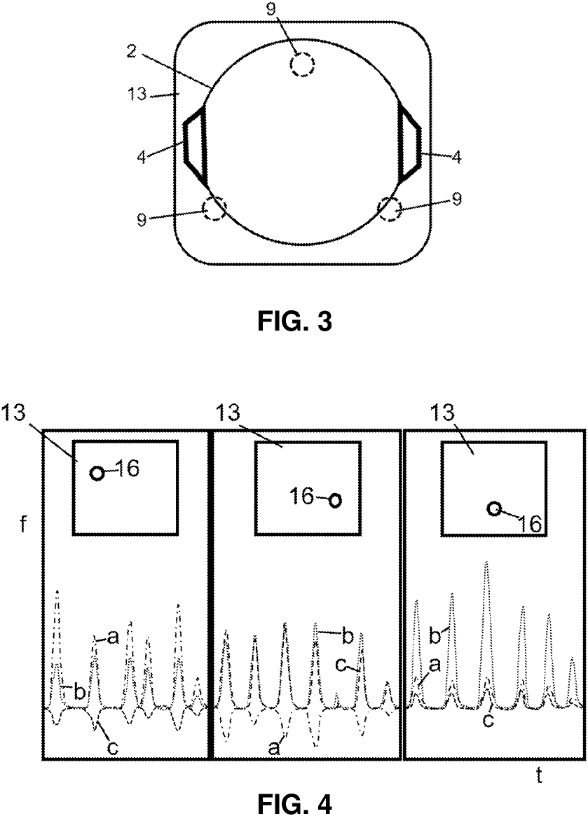

FIG. 3 shows a top view of a kitchen appliance having an upper side 13. On the upper side 13 there is a preparation vessel 2. The preparation vessel 2 may comprise an integrated heater to be able to heat the preparation vessel 2. The preparation vessel 2 may be firmly attached to the upper side 13. The preparation vessel 2 may be placed on a placement surface of the upper side 13. The preparation vessel 2 may then be removed from the placement surface and used in a mobile manner. Alternatively, the placement surface may be heatable to allow the preparation vessel 2 to be heated. In a further configuration, the placement surface may comprise coils whereby the preparation vessel may be inductively heated.

The kitchen appliance shown in FIG. 3 is configured such that it can detect when a handle 4 of the preparation vessel 2 is pressed. If a handle is pressed, the operation of the kitchen appliance can be controlled. If the lid of the kitchen appliance is pressed, the operation of the kitchen appliance cannot be controlled or only very limited control options are available, such as switching on a weighing function for weighing foodstuffs that are placed in the preparation vessel 2. The kitchen appliance may be configured such that the upper side 14, which is located next to the preparation vessel 2, can also be used for controlling the operation of the kitchen appliance.

However, it is also possible that the handle 4 is pulled, thereby causing a tilting movement and thus controlling the operation of the kitchen appliance.

In FIG. 4, a section of an edge area of an upper side 13 of a kitchen appliance is shown. In a test carried out, there was a first force sensor at the top left, a second force sensor at the bottom center, and a third force sensor at the top right, as viewed from above the upper side 13. The arrangement of the force sensors below the upper side 13 corresponded to the arrangement shown in FIG. 2. Three different test results are shown. In the three different tests, different positions 16 were pressed several times with different forces. In some cases, the different positions were only 10 mm apart.

Plotted in FIG. 4 below the cutouts of an upper side 13 is the force f against time t. There is a measurement curve a for the first force sensor, which is represented by a dash-dot line. There is a measurement curve b for the second force sensor, which is represented by a dotted line. There is a measurement curve c for the third force sensor, which is represented by a dashed line.

In the first test, pressing was performed on the left side in the upper half of the section of upper side 13 (position 16 in the first section of upper side 13 shown on the left). The first force sensor registered strong forces f and the third force sensor still registered relatively strong forces f. The second force sensor registered negative forces. The first and third feet were thus loaded. The second foot was unloaded.

In the second test, pressing was performed on the right side in the lower half (position 16 in the second section of the upper side 13 shown in the center). The first force sensor registered negative forces f. The other two force sensors registered approximately equal forces f. The first foot was thus unloaded. The other two feet were loaded to a similar extent.

In the third test, pressing was performed in the lower half in the center (position 16 in the third section of the upper side 13 shown on the right). The second force sensor registered strong forces f. The other two force sensors registered forces f of approximately similar strength. The second foot was consequently heavily loaded. The other two feet were loaded approximately similarly, but comparatively weakly.

The experiments illustrate that very different measurement results are obtained in dependence on the position of the pressing, which can also be clearly assigned to the respective position.

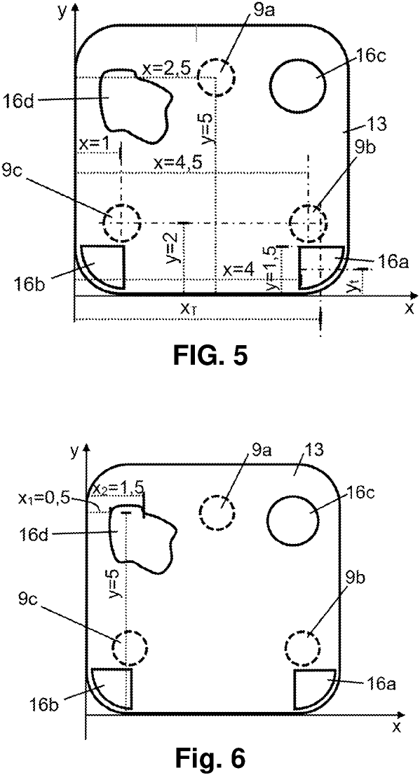

The following describes how measurement results can be evaluated. The device shown in FIG. 5 is shown in top view. It stands on three indicated feet 9a, 9b and 9c. The feet 9a, 9b and 9c are located on the underside of the device and are force sensors of a scale. The exact position of the feet 9a, 9b, 9c is known. In addition, four different housing regions 16a, 16b, 16c and 16d are marked on the top of the device 13, via which touch inputs, i.e. inputs by pressing, are permitted. In the following example, touch input is to be made via the front right corner and thus via the housing region 16a and uniquely assigned to this region 16a via the three feet 9a, 9b and 9c.

Thus, the positions of the three feet of the scale can first be determined in the device-fixed x/y coordinate system (see also the values of the coordinates given in FIG. 5):
scale foot 9a: (2.5 / 5)
scale foot 9b: (4.5 / 2)
scale foot 9c: (1 / 2)

Now, three (in the first step static, linearly independent) mechanical equations can be used to determine the position of the force application point in the x/y coordinate system and the magnitude of the force f in dependence on the measured forces f₉ₐ, f_{9b}, f_{9c}, wherein f₉ₐ is the force measured by scale foot 9a, f_{9b} is the force measured by scale foot 9b, and f_{9c} is the force measured by scale foot 9c.

For the equilibrium of all forces f_{z} in the z-direction (i.e. into the plane shown), the following applies: The sum of all forces introduced from outside equals the sum of the forces at the (three) scale feet 9a, 9b, 9c:

$$\sum {\text{f}}_{\text{z}} = 0 ↔ {\text{f}}_{\text{9a}} + {\text{f}}_{\text{9b}} + {\text{f}}_{\text{9c}} = \text{f}$$

In addition, two equations result from the moment equilibria for the moment forces Mx about the x-axis and My about the y-axis.

For the equilibrium of moments around the x-axis the following applies:

$$\sum \text{Mx} = 0 ↔ {\text{f}}_{\text{9a}} \text{*} {\text{y}}_{\text{9a}} + {\text{f}}_{\text{9b}} \text{*} {\text{y}}_{\text{9a}} + {\text{f}}_{\text{9c}} \text{*} {\text{y}}_{\text{9c}} = {\text{f*y}}_{\text{t}} ,$$

wherein y₉ₐ is the y-coordinate of the foot 9a, y_{9b} is the y-coordinate of the foot 9b and y_{9c} is the y-coordinate of the foot 9c.

If the corresponding coordinates from FIG. 5 are now substituted into the equation, it follows:

$$\sum \text{Mx} = 0 ↔ {\text{f}}_{\text{9a}} \text{*} 5 + {\text{f}}_{\text{9b}} \text{*} 2 + {\text{f}}_{\text{9c}} \text{*} 2 = {\text{f*y}}_{\text{t}}$$

For the equilibrium of moments about the y-axis, the following applies accordingly:

$$\sum \text{My} = 0 ↔ {\text{f}}_{\text{9a}} \text{*} {\text{x}}_{\text{9a}} + {\text{f}}_{\text{9b}} \text{*} {\text{x}}_{\text{9a}} + {\text{f}}_{\text{9c}} \text{*} {\text{x}}_{\text{9c}} = {\text{f*x}}_{\text{t}} ,$$

wherein x₉ₐ is the x-coordinate of the foot 9a, x_{9b} is the x-coordinate of the foot 9b and x_{9c} is the x-coordinate of the foot 9c.

If the coordinates shown in FIG. 5 are used, it follows:

$$\sum \text{My} = 0 ↔ {\text{f}}_{\text{9a}} \text{*} 2 , 5 + {\text{f}}_{\text{9b}} \text{*} 4 , 5 + {\text{f}}_{\text{9c}} \text{*} 1 = {\text{f*x}}_{\text{t}}$$

These three linearly independent equations have three unknowns:
Force of touch input f
x-coordinate of the touch input xₜ
y-coordinate of the touch input yₜ.

This system of equations can be solved uniquely. In other words, the three measured values of the force sensors 9a, 9b, 9c can be used to unambiguously calculate where a vertical force was introduced into the device and what its magnitude is.

If the corresponding housing regions are described mathematically and stored digitally, for example in a database, touch inputs in different housing regions can be distinguished from one another and, in addition, the force of the touch input can be recorded. For example, the housing region 16a was clicked, i.e., it was pressed on the housing region 16a, if the determined x value of the touch input is >4 and at the same time the y value of the touch input is <1.5.

Arbitrary housing regions can be digitally stored in a database by the line-by-line description. If the entire surface of a housing region to be used for touch input is described line by line, each row value y is assigned a corresponding x-range. For example, in FIG. 6, a row of housing region 16c is described by Y=5 and 1.5≥X≥0.5. If each row 0=y≤6 of the housing surface is thus described, a binary value “touch region: yes” or “touch region: no” can be assigned to a touch input and corresponding touch inputs can be responded to or not responded to.

Alternatively, the surface can also be described column by column.

The method shown here as an example for the x/y plane can also be transferred to the other two spatial planes (y/z), (x/z) or corresponding combinations of these. In this way, touch inputs, i.e. inputs by pressing, can also be detected and differentiated on surfaces lying obliquely in space. For this purpose, the corresponding distances must be exchanged and/or projected in the above equations. Differentiation measures can be applied here to reliably distinguish between a scheduled touch input and unscheduled touch inputs to eliminate misinterpretation of touch inputs. Differentiation measures may include assuming a minimum pressure and/or a maximum pressure and/or a minimum pressure increase and/or a maximum pressure increase and/or a minimum time period for pressing and/or a maximum time period for pressing to be recognized as a scheduled pressing or a scheduled touch input.

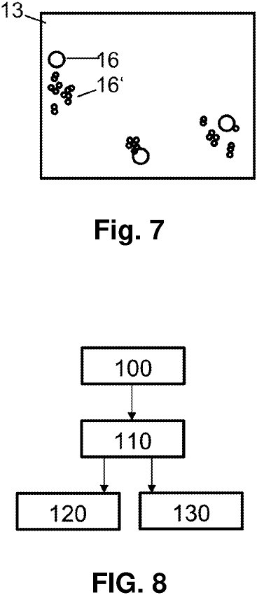

FIG. 7 shows an evaluation of the measurement curves of FIG. 4, in which error compensation calculations and optimizations were omitted. Shown are the positions 16 that were pressed. The small circles 16′ in the neighborhood of the respective positions 16 are the positions determined by the evaluation. Although some of the positions were only 10 mm apart, the different positions could be clearly distinguished. The evaluation also confirmed that very precisely different positions can be distinguished, even if they are only a few millimeters apart.

An evaluation can be carried out in a static implementation as indicated below:
The three force-sensor information or signals are detected over time (step 100 in the flow chart of FIG. 8).
The maximum values of these single values are detected by observing the slope over time (step 110 in the flow chart of FIG. 8). The maximum values can be determined by determining the derivative = 0 and by changing the sign of the derivative from + to - shortly before and after the maximum value.
Taking the three singular values at the time of the maximum values and calculating the position (step 120 in the flow chart of FIG. 8).
Three individual values can be added up to determine the vertical force applied, for example, to obtain weight information (step 130 in the flow diagram of FIG. 8).
During the evaluation, differentiation measures of force sensor information described above can be taken into account, which serve to distinguish a scheduled pressing from unscheduled force application.

In the dynamic case (relevant for a slider, for example), the force sensor information can be recorded further after a detected initial pressing (see static case above). Now, in subsequent time steps, the positions are calculated from the three force sensor information in each case in order to detect a wiping movement or sliding movement.

Under certain circumstances, a wiping movement can also be detected without initial contact because it takes place, for example, at a housing position provided for this purpose. For this purpose, a groove or similar depression or elevation can be incorporated into the upper side to guide the wiping movement and guide the user.

By kitchen appliance is meant a set of parts, at least loosely connected to each other, that are used together to prepare a food. A hob with a cooking pot placed on a hob is then a set of parts constituting a kitchen appliance. A food processor operated together with an accessory attached to the food processor is an assembly of parts constituting a kitchen appliance.

By pressing is meant that a user of the kitchen appliance exerts a pressure on the kitchen appliance with a body part. The body part can be a finger. If a tilting movement is exerted on the kitchen appliance by pulling upwards, the weight of the kitchen appliance is shifted as a result. Such a tilting movement is basically equivalent to pressing on a position on the upper side of the kitchen appliance. For example, pulling a side handle of a preparation vessel upward can cause a tilting movement corresponding to pressing on a position on the upper side of the kitchen appliance. However, fully lifting a kitchen appliance by pulling upward does not correspond to pressing on a position on the upper side of the kitchen appliance.

Pulling upwards can result in at least one force sensor of the scale being loaded and at least one other force sensor of the scale being unloaded. It is possible that force sensors of the scale are arranged in such a way that unloading of a force sensor can only be achieved by pulling upwards. This can be the case, for example, if force sensors are arranged exclusively on the outer circumference of the kitchen appliance. In this case, a distinction can be made between pulling upwards and pressing on the upper side. In particular, pulling can then be an additional input option for controlling the kitchen appliance.

With a pulling upwards a kitchen appliance can be controlled differently compared to a pressing on the upper side, if the kitchen appliance is configured such that a distinction can be made between a pulling and a pressing. Also, the position of a pulling upwards can optionally be detected. Thus, the kitchen appliance can be controlled by the control device also in connection with a pulling upwards in dependence on the position.

By upper side is meant a surface of the kitchen appliance that can be reached from above when the kitchen appliance is set up as intended. If pressure is applied to the upper side, there is a force that acts vertically on the kitchen appliance. A vertical side wall of the kitchen appliance is not an upper side of the kitchen appliance, since such a side wall cannot be pressed from above. If a vertical side wall is pressed from the side, there is no pressure force exerted directly by the user that acts vertically on the kitchen appliance. This does therefore principally not have the effect that the control device can control the operation of the kitchen appliance due to a pressing on the vertical side wall. However, pressing on a vertical side wall may cause a tilting movement and an associated weight shift. As described above, such a tilting movement basically corresponds to pressing on a position on the upper side of the kitchen appliance.

By control of the operation of the food preparation device, it is meant that a state of the kitchen appliance is changed.

Changing the state of the kitchen appliance means, for example, switching on or switching off the kitchen appliance. If the kitchen appliance is in the switched-off state, the kitchen appliance cannot be used to prepare a food. Preparing food therefore requires the switched-on state. An operating system of the kitchen appliance can be started in the switched-on state of the kitchen appliance. In the switched-on state of the kitchen appliance, electrical consumers such as the display may be switched on. If such a kitchen appliance is switched off, then this may mean the shutdown of the operating system. In addition, consumers such as the display can be switched off when the kitchen appliance is switched off.

A change of the state of the kitchen appliance means, for example, adjusting (setting) and/or changing a desired temperature which shall be reached in a preparation space of the food preparation device, adjusting and/or changing a movement speed of a tool or a desired temperature or another component of the kitchen appliance, or adjusting and/or changing a timer of the kitchen appliance.

For example, if the kitchen appliance comprises a mixing and/or cutting tool, a rotational speed of the mixing and/or cutting tool can for example be changed by pressing. A mixing tool can be used to mix foodstuffs. A cutting tool can be used to chop foodstuffs. A tool that can be used to both mix and chop may comprise a shaft and one or more blades protruding from the shaft. The blades may be sharp-edged on one side for chopping and blunt-edged on an opposite side. If rotated in the direction of the blunt edge, then basically only mixing will occur. This is true at least when rotating at a low speed of, for example, no more than 1000 revolutions per minute or no more than 500 revolutions per minute. If rotated in the direction of the sharp edge, chopping is basically performed. This is true at least when rotating at a high speed of, for example, at least 2000 revolutions per minute or at least 5000 revolutions per minute.

If the kitchen appliance comprises, for example, a fan, then a rotational speed of the fan can be changed by pressing, for example.

A change in the state of the kitchen appliance may comprise activating or deactivating a measurement. For example, a weight measurement can be activated. If weight measurement is activated and if a foodstuff is brought to a preparation space of the kitchen appliance, for example, the weight of the foodstuff in the preparation space may be shown on a display of the kitchen appliance, for example. If the weight measurement is deactivated, no measured weight is shown on the display. A measurement and a display of a measured value are not a change in the operating state of the kitchen appliance in the sense of the present present disclosure.

A change in the state of the kitchen appliance may comprise activating or deactivating a program or a step in a program of the kitchen appliance. For example, a program for preparing a foodstuff in an automated or semi-automated manner may be activated or deactivated. For example, a step in a program for an automated or semi-automated preparation of a foodstuff may be activated.

A change in the state of the kitchen appliance may comprise a restart of the kitchen appliance.

A change in the state of the kitchen appliance may comprise changing an information state of the kitchen appliance that may affect further operation of the kitchen appliance. For example, pressing on the upper side of the kitchen appliance may signal the presence of a user to the kitchen appliance. Subsequently, the kitchen appliance has the information that a user is present or present again as a prerequisite for other state changes that are only possible when a user is present.

Thus, a change in the state of the kitchen appliance may comprise changing binary values of the kitchen appliance such as switched on or switched off, changing discrete values such as values for speed steps for a mixing and/or cutting tool, or changing such values continuously.

Depending on the detected position, the operation of the kitchen appliance can be controlled. For example, if the central position is pressed, weighing can be activated or deactivated. If weighing is activated, the weight of a foodstuff can be measured by the kitchen appliance and displayed visually and/or acoustically, for example. This is not possible in the deactivated state. For example, if the upper side of the kitchen appliance is pressed outside the central area, the kitchen appliance can be switched on or off.

The area (region) of the bottom of a preparation space of the kitchen appliance and/or the area just above the bottom (exactly above the bottom) of a preparation space of the kitchen appliance and/or the area of a placement surface for a preparation vessel can be excluded at least during a predetermined operating state of the kitchen appliance from the fact that the operation of the kitchen appliance can be controlled by pressing.

Thus, pressing on the bottom of the preparation space at least during a predetermined operating state does not result in the scale detecting the pressing and then in controlling the operation of the kitchen appliance in dependence on the detected pressing. For example, if the user presses with a finger on an upper side of the kitchen appliance, which is located next to the bottom of the preparation space when viewed from above the kitchen appliance, the operation of the kitchen appliance can be controlled independently of the operating state of the kitchen appliance.

If the kitchen appliance comprises a placement surface on which a preparation vessel for preparing a food can be placed, the area of the placement surface can be excluded at least during a predetermined operating state of the kitchen appliance from the fact that an operating state of the kitchen appliance can be changed by pressing. Thus, pressing on the placement surface does not result in the scale detecting the pressing and then controlling the operation of the kitchen appliance in dependence on the detected pressing.

An area just above the bottom of a preparation space of the kitchen appliance may be excluded at least during a predetermined operating state of the kitchen appliance. Thus, pressing on an area of the kitchen appliance that is just above the bottom of the preparation space does not then result in the operation of the kitchen appliance being controlled in dependence on the detected pressing. The area above the bottom can be for example a lid of a preparation vessel. If pressing is performed on the lid and the lid is located just above the bottom in top view of the lid and not, for example, laterally next to the bottom, then this cannot cause the control device to control the operation of the kitchen appliance. This is true at least for a predetermined operating state.

It can thus be avoided that a filling of foodstuffs into the food preparation space is unscheduledly understood by the control device such that the operation of the kitchen appliance is to be controlled in a predetermined manner.

For example, pressing on a bottom of a food preparation space of the kitchen appliance, on an area just above the bottom of the food preparation space, and/or on a placement surface of the kitchen appliance may switch on the kitchen appliance. After switching on, it may no longer be possible to control the operation of the kitchen appliance by pressing on the bottom of a food preparation space of the kitchen appliance, on an area just above the bottom of the food preparation space and/or by pressing on the placement surface of the kitchen appliance. So it is not always excluded that pressing on the bottom can control the operation of the kitchen appliance. Instead, this only applies in the switched-on state of the kitchen appliance.

It can thus be avoided that a filling of foodstuffs into the food preparation space is unscheduledly understood by the control device such that the operation of the kitchen appliance is to be controlled in a predetermined manner.

It may be, for example, that in the switched-on state of the kitchen appliance, pressing on a bottom of a food preparation space of the kitchen appliance, on an area just above the bottom of the food preparation space and/or on a placement surface of the kitchen appliance may activate the scale such that foodstuffs may be weighed. When the scale is activated, it is no longer possible to control the operation of the kitchen appliance by pressing on the bottom of a food preparation space of the kitchen appliance, on an area just above the bottom of the food preparation space and/or by pressing on the placement surface of the kitchen appliance. If a vertical force is then applied to the bottom of the food preparation space, to the area just above the bottom and/or to the placement surface, only a weight is measured and, for example, displayed.

It can thus be avoided that a filling of foodstuffs into the food preparation space is unscheduledly understood by the control device such that the operation of the kitchen appliance is to be controlled in a predetermined manner.

The kitchen appliance may be configured such that by determining the position, it is determined whether pressing has been performed on the bottom of the preparation space, on the area just above the bottom and/or on the placement surface.

The kitchen appliance may be configured such that the scale is deactivated in an automated manner in the event of inactivity after a predetermined period of time has elapsed. For example, a period of two, three, four or five minutes may be predetermined. If no weight measurement takes place within this period, the scale is not used for weighing. In this sense, the scale is inactive. The possibility of weighing is then deactivated. In particular, the kitchen appliance does not display or otherwise transmit any weight data.

Pressing on a bottom of a food preparation space of the kitchen appliance, on an area just above the bottom of the food preparation space and/or on a placement surface of the kitchen appliance can always have the consequence that the operation of the kitchen appliance cannot be controlled by such a pressing. In this case, the operating state of the kitchen appliance is not important. In this way, it can be avoided in a particularly reliable way that a filling of foodstuffs into the food preparation space is unscheduledly understood by the control device such that the operation of the kitchen appliance is to be controlled in a predetermined manner.

The scale of the kitchen appliance may comprise several force sensors for weight measurement and for determining the position of the pressing. The force sensors are spatially separated from each other when the kitchen appliance is viewed from above. The force sensors are therefore juxtaposed (arranged side by side). If a weight is measured by the kitchen appliance, a weight force is applied to the force sensors. Thus a weight of a foodstuff can be measured.

If a position is pressed that is exactly above a first force sensor, this first force sensor measures a greater force than another second force sensor that is spatially arranged next to the first force sensor. If a position just above the second force sensor is pressed, this second force sensor measures a larger force than the first force sensor. Thus, the provision of juxtaposed force sensors facilitates the detection of a position on the upper side of the kitchen appliance that has been pressed upon. The kitchen appliance may thus be configured such that the position of a pressing on the upper side of the food preparation appliance can be determined from the forces applied to juxtaposed force sensors. Since the force sensors are part of the scale, the scale can detect the position of the pressing.

If a row on the upper side is to be used for a pressing and an associated operation of the kitchen appliance, then two force sensors can be arranged along a line that runs parallel to the row. Positions along the row can then be determined very accurately. A force sensor can be arranged adjacent to each end of a row. However, this is not necessary to be able to determine a position very precisely. However, there should be a minimum distance of at least 2, 3 or 4 cm between the two force sensors in order to be able to determine positions. For example, one row on the upper side should serve as a slider. Two force sensors can then advantageously be arranged along a line that runs parallel to the row serving as a slider.

Preferably, there are at least three juxtaposed force sensors arranged in a two-dimensional distribution. The force sensors are therefore not arranged exclusively along a straight line. The available upper side of the kitchen appliance can then be used particularly completely for controlling the operation of the kitchen appliance.

Preferably, there are exactly three juxtaposed force sensors, which are arranged distributed in two dimensions. The three force sensors then span (form) a triangle. The available upper side of the kitchen appliance can then be used particularly completely for controlling the operation of the kitchen appliance without having to use an excessive number of force sensors.

The distance between juxtaposed force sensors can always be at least 5 cm, preferably always at least 8 cm, particularly preferably always at least 10 cm. In an improved manner, the position on the upper side of the kitchen appliance can thus be determined very precisely.

Preferably, the force sensors form feet of the kitchen appliance. The kitchen appliance is set up on the feet in order to be able to use the kitchen appliance as intended for preparing a food. In this embodiment, the force sensors are used twice. The technical manufacturing effort can thus be kept low. If there are only three force sensors, then there are only three feet. The kitchen appliance can then be set up very stably without requiring a level base.

However, it is also possible to have more than three force sensors that can serve as feet. For example, four, five or six feet can be provided that are also force sensors of the scale.

Force sensors can be arranged on the circumference of a circle. Immediately adjacent force sensors can then always be equally spaced. Also in this way, the position on the upper side of the kitchen appliance that was pressed can be determined very precisely.

The kitchen appliance can be configured such that by means of the scale the strength of the pressure force on the kitchen appliance caused by a pressing can be detected. The control device of the kitchen appliance may be configured such that it can control the operation of the kitchen appliance in dependence on the strength of the pressing force. This embodiment extends the capabilities of the user interface to control and operate the operation of the kitchen appliance in a particularly versatile and/or particularly intuitive manner. For example, a particularly strong pressing with a force above a predetermined pressure threshold can cause the kitchen appliance to be switched on or switched off. For example, a particularly strong pressing with a force above a predetermined pressure threshold can cause a desired temperature or a speed of a tool or fan to be increased continuously or in steps. Thus, in this embodiment, the operation of the kitchen appliance may be controlled in dependence on predetermined pressure thresholds.

The kitchen appliance may be configured such that a change in the position of pressing on the upper side of the kitchen appliance can be detected by means of the scale. The control device of the kitchen appliance may be configured such that it is able to control the operation of the kitchen appliance in dependence on the change in position. This embodiment extends the capabilities of the user interface to control the operation of the kitchen appliance in a particularly versatile and/or particularly intuitive manner. In this embodiment, sliding movements and/or wiping movements on the upper side of the kitchen appliance can be used to control operation. For example, a sliding movement in a first direction can cause the rotational speed of a tool of the kitchen appliance or fan or a desired temperature to be increased. A sliding movement and/or wiping movement in the opposite direction can cause the rotational speed of a tool of the kitchen appliance or fan or a desired temperature to be decreased.

Preferably, at least two force sensors are arranged parallel and adjacent to the area provided for a sliding movement or wiping movement. A wiping movement can then be detected particularly accurately. An imaginary line between two force sensors then runs parallel to the area provided for a rectilinear wiping movement, for example. The two force sensors can, for example, be present exactly under the area provided for a wiping movement. The area for a wiping movement can then be characterized, for example, by a rectilinearly extending groove or a rectilinearly extending elevation. The area for a wiping movement may be color-coded.

The kitchen appliance may be configured such that the duration of pressing on the upper side of the kitchen appliance may be detected by means of the scale. The kitchen appliance may be configured such that the control device may control the operation of the kitchen appliance in dependence on the duration. In this embodiment, one or more duration thresholds may be predetermined. For example, a duration threshold may be three seconds. If the upper side of the kitchen appliance is pressed for longer than three seconds, the kitchen appliance may be switched on or switched off, for example. The kitchen appliance can thus be controlled in dependence on predetermined duration thresholds. This embodiment extends the possibilities of the user interface to control the operation of the kitchen appliance in a particularly versatile and/or particularly intuitive manner.

The kitchen appliance may be configured such that the frequency of pressing within a predetermined time period can be detected by means of the scale. The kitchen appliance may be configured such that the control device of the kitchen appliance is able to control the operation of the kitchen appliance in dependence on the frequency. For example, a time period of two seconds, three seconds, or four seconds may be specified. If pressed only once within such a predetermined time period, the operation of the kitchen appliance is controlled differently compared to pressing twice or pressing three times within the predetermined time period.

Combinations are possible. For example, it may be necessary to first press on a front left half of the housing so that subsequent pressing on a right half of the housing with increased force can then change values, for example speed values or desired temperature values, continuously or in steps.

The kitchen appliance may thus be configured such that by means of the scale the kitchen appliance can be switched on and/or switched off. The kitchen appliance can thus be configured such that by means of the scale, values adjustable for the operation of the kitchen appliance, for example values for rotational speeds or values for desired temperatures, can be adjusted continuously or in steps by means of the scale. This can be done in dependence on the position of the pressing or in dependence on the type of pressing.

For example, the kitchen appliance may be configured such that a strong pressing on the kitchen appliance detected by the scale causes the kitchen appliance to shut down. For example, the kitchen appliance may be configured such that a blow to the kitchen appliance detected by the scale, and thus a particularly short pressing, causes the kitchen appliance to be switched off in an emergency. The kitchen appliance can, for example, be configured such that a light pressing detected by the scale switches on a function of the kitchen appliance. A light pressing can, for example, switch on or off rotation of a mixing tool and/or cutting tool of the kitchen appliance and, thus, switch on or off a function of the kitchen appliance. By a light pressing, for example, the adjustment of a desired temperature of the kitchen appliance and, thus, a function of the kitchen appliance can be switched on (activated) or switched off (deactivated). By a light pressing, for example, the weighing and displaying of a weight and thus a function of the kitchen appliance can be switched on or switched off. By a light pressing, for example, a displayed weight can be reset to zero during weighing.

If a desired temperature can be adjusted in a kitchen appliance, then the kitchen appliance comprises a temperature control device to be able to achieve an adjusted desired temperature. A temperature control device can cool and/or heat. For example, the kitchen appliance may comprise a heating device. The heating device may be located in the preparation space and/or preparation vessel. The preparation space and/or preparation vessel may be brought to a desired temperature, for example, by induction. A base appliance may comprise means for inductively heating a preparation space and/or preparation vessel.

The kitchen appliance may be configured such that a control device of the kitchen appliance can control operation of the kitchen appliance in dependence on a detected pressing on the upper side of the kitchen appliance only if the pressure exceeds a predetermined minimum pressure threshold and/or if the pressure falls below a predetermined maximum pressure threshold.

By providing a minimum pressure threshold, it can be avoided that an accidental touch of the kitchen appliance causes an unscheduled state change. Malfunctions can thus be avoided.

By providing a maximum pressure threshold, it can be avoided that an unscheduled state change can be caused due to a pressure force that can hardly be achieved by pressing with a finger. Alternatively or complementarily, it can be achieved that a user will avoid pressing with an excessive force. Malfunctions can be avoided in this way.

The kitchen appliance may be configured such that a control device of the kitchen appliance can control operation of the kitchen appliance in dependence on a detected pressing on the upper side of the kitchen appliance only if a predetermined minimum pressure rise threshold is exceeded and/or if the pressure exceeds a predetermined maximum pressure rise threshold. Thus, there may be differentiation measures to distinguish between intentional and unintentional inputs in a particularly reliable manner.

If the upper side of the kitchen appliance is pressed with a finger, the pressure increases in dependence on the movement speed of the finger. There are typical values for an increase in the then measured pressure force. If a measured pressure force increases in an atypical manner, this is an indication that the upper side of the kitchen appliance was not pressed with a finger as planned. By providing pressure rise thresholds, it can therefore be achieved in an improved manner that only a scheduled pressing on the upper side of the kitchen appliance can cause a control of the operation of the kitchen appliance.

The kitchen appliance may be configured such that the kitchen appliance is able to prepare a food in an at least partially automated manner by means of an electronically stored recipe. The kitchen appliance may be configured such that a control device of the kitchen appliance is able to control operation of the kitchen appliance in dependence on a detected pressing on the upper side of the kitchen appliance in combination with information dependent on the recipe. Thus, it is comprised that at least during a recipe-controlled, partially automated or automated preparation of a food, a pressing on the upper side of the kitchen appliance causes a control only when this is provided by the recipe. Alternatively or additionally, at least during a recipe-controlled, partially automated or automated preparation of a food, pressing on the upper side may change the state of the kitchen appliance only in a manner which is predetermined by the recipe. For example, during the preparation of a food, the recipe may provide that a desired temperature is adjusted. By pressing lightly on the upper side, only the desired temperature predetermined by the recipe can be adjusted. Any other condition of the kitchen appliance cannot be changed by pressing lightly. Malfunctions due to unscheduled force exerted on the upper side of the kitchen appliance can thus be reliably avoided.

At least during a recipe-controlled, partially automated or automated manner of preparing a food, for example, a light pressing can always only effect what is predetermined according to the recipe. Usually, a light pressing will confirm that an adjustment (setting) provided according to the recipe is to be made, such as adjusting a rotation speed for a mixing and/or cutting tool, adjusting a desired temperature or adjusting a timer. Instead of a light pressing, a long pressing, a pressing twice within a predetermined time period or a wiping movement can be provided. Disturbances due to unscheduled force exerted on the upper side of the kitchen appliance can thus be avoided particularly reliably.

A position for pressing can be provided in the case of recipe-controlled, semi-automated or fully automated preparation of a food in order to be able to exit the recipe-controlled preparation of a food.

The kitchen appliance may be configured such that the control device of the kitchen appliance is able to control the operation of the kitchen appliance in dependence on a detected pressing on the upper side of the kitchen appliance in combination with an appliance state of the kitchen appliance. By this is meant that in case of a pressing on the upper side, the control device checks the state of the kitchen appliance and controls the operation of the kitchen appliance in dependence on the result of this check.

For example, the kitchen appliance prepares a food semi-automatically step by step by means of a recipe. In the course of food preparation, the kitchen appliance may expect a specific input such as a confirmation that a next step of the recipe is to be performed. This can be signaled to the user on a display, for example, with “continue”. Pressing on a specific position or alternatively on any position on the upper side can now trigger the start of the next recipe step. The specific position can be marked visually, for example by “ok”. If the kitchen appliance expects a specific input, this can be connected with the fact that there are other inputs or control possibilities by pressing, which are temporarily excluded at this time.

For example, an area of handles of a preparation vessel may be available for control by pressing only if a base appliance of the kitchen appliance has detected the presence of the preparation vessel. For example, the kitchen appliance may optionally comprise a cutting disc for defined chopping of foodstuffs, which may only be operated at low speeds of, for example, less than 1000 revolutions per minute. If the kitchen appliance detects the presence of the cutting disc, adjusting higher speeds by pressing or wiping movements can be excluded.

The fact that adjustment options can be temporarily excluded in dependence on a detected appliance state represents an independent present disclosure. This applies in particular to the state-dependent limitation of speeds in a food processor that can be operated with optional accessories such as a cutting disc or juice press, and to the state-dependent limitation of maximum possible desired temperatures.

If preparation vessels of different sizes can be used, a selected preparation vessel can be an appliance state that affects the control options by pressing on the upper side of the kitchen appliance. This may apply in a corresponding manner to orientations of accessories.

The kitchen appliance may comprise a base appliance having a placement surface for a preparation vessel. The control device of the kitchen appliance is able to control selected functions of the kitchen appliance in dependence on a detected pressing on the upper side of the housing, for example, only when the preparation vessel is placed on the placement surface. This can also help to avoid malfunctions due to unscheduled pressing.

The kitchen appliance may be a food processor comprising a mixing and/or cutting tool in the preparation vessel and a motor in the base appliance for driving the mixing and/or cutting tool. A food processor may further comprise a heating device for heating the preparation vessel.

1. A kitchen appliance comprising
a control device for controlling the operation of the kitchen appliance and
a scale for measuring a weight of foodstuffs,
wherein the control device of the kitchen appliance is configured to control the operation of the kitchen appliance in dependence on a pressing on the upper side of the kitchen appliance detected by the scale in dependence on the position of the pressing.

2. The kitchen appliance of claim 1, wherein at least one of the area of the bottom of a preparation space of the kitchen appliance, the area just above the bottom of a preparation space of the kitchen appliance, the area of a placement surface (14) for a preparation vessel is excluded from the fact that the operation of the kitchen appliance can be controlled at least during a predetermined operating state of the kitchen appliance.

3. The kitchen appliance of claim 1, wherein the kitchen appliance comprises juxtaposed force sensors configured for a weight measurement and configured for a determination of the position of pressing.

4. The kitchen appliance of claim 3, wherein the kitchen appliance comprises exactly three juxtaposed force sensors, which are arranged in a two-dimensionally distributed manner.

5. The kitchen appliance of claim 3, wherein each force sensor is a foot of the kitchen appliance.

6. The kitchen appliance of claim 5, wherein the kitchen appliance is configured such that from the forces exerted on the feet and detected by the scale, the position of a pressing on the food preparation appliance is determined.

7. The kitchen appliance of claim 1, wherein the kitchen appliance is configured such that the strength of the pressure force on the upper of the kitchen appliance caused by a pressing can be detected by means of the scale and the control device of the kitchen appliance is able to control the operation of the kitchen appliance in dependence on the strength of the pressure force.

8. The kitchen appliance of claim 1, wherein the kitchen appliance is configured such that a change in the position of pressing on the upper side of the kitchen appliance can be detected by means of the scale and the control device of the kitchen appliance is able to control the operation of the kitchen appliance in dependence on the change in position.

9. The kitchen appliance of claim 1, wherein the kitchen appliance is configured such that the duration of pressing on the upper side of the kitchen appliance can be detected by means of the scale, and the control device of the kitchen appliance is able to control the operation of the kitchen appliance in dependence on the duration.

10. The kitchen appliance of claim 1, wherein the kitchen appliance is configured such that the frequency of pressing on the upper side of the kitchen appliance within a predetermined time period can be detected by means of the scale and the control device of the kitchen appliance is able to control the operation of the kitchen appliance in dependence on the frequency.

11. The kitchen appliance of claim 1, wherein the kitchen appliance can be switched on and/or off by means of the scale.

12. The kitchen appliance of claim 1, wherein values adjustable for the operation of the kitchen appliance can be adjusted continuously or stepwise by means of the scale.

13. The kitchen appliance of claim 1, wherein the kitchen appliance is configured such that the kitchen appliance is shut down by a strong pressing on the kitchen appliance detected by the scale.

14. The kitchen appliance of claim 1, wherein the kitchen appliance is switched off in an emergency by a blow on the kitchen appliance detected by the scale and a function of the kitchen appliance is switched on by a light pressing detected by the scale.

15. The kitchen appliance of claim 14, wherein the weighing function for weighing foodstuffs is switched on by a light pressing detected by the scale.

16. The kitchen appliance of claim 1, wherein the kitchen appliance is configured such that a control device of the kitchen appliance is able to control the operation of the kitchen appliance in dependence on a detected pressing on the upper side of the kitchen appliance corresponding to at least one of:
(i) only if the pressure exceeds a predetermined minimum pressure threshold, (ii) if the pressure falls below a predetermined maximum pressure threshold, (iii) if the pressure exceeds a predetermined minimum pressure rise threshold, and (iv) if the pressure falls below a predetermined maximum pressure rise threshold.

17. The kitchen appliance of claim 1, wherein the kitchen appliance is able to prepare a food by means of an electronically stored recipe in an at least partially automated manner and the kitchen appliance is configured such that a control device of the kitchen appliance is able to control the operation of the kitchen appliance in dependence on a detected pressing on the upper side of the kitchen appliance in combination with information dependent on the recipe.

18. The kitchen appliance of claim 1, wherein the kitchen appliance is configured such that a control device of the kitchen appliance is able to control the operation of the kitchen appliance in dependence on a detected pressing on the upper side of the kitchen appliance in combination with an appliance state of the kitchen appliance.

19. The kitchen appliance of claim 18, wherein the kitchen appliance comprises a base appliance having a placement surface for the preparation vessel and the control device of the kitchen appliance is able control a function of the kitchen appliance in dependence on a detected pressing on the upper side of the housing only when the preparation vessel is placed on the placement surface.

20. The kitchen appliance of claim 19, wherein the kitchen appliance is a food processor comprising a mixing and/or cutting tool in the preparation vessel and a motor in the base appliance for driving the mixing and/or cutting tool, and optionally a heating device.
